(19) United States
(12) Patent Application Publication
(10) Pub. No.: US 2016/0174132 A1
(43) Pub. Date: Jun. 16, 2016

(54) METHOD AND APPARATUS FOR LIMITING THE USE OF A MOBILE COMMUNICATIONS DEVICE

(71) Applicant: Ciaran HYNES, Beverly, MA (US)

(72) Inventor: Ciaran HYNES, Beverly, MA (US)

(21) Appl. No.: 14/903,974

(22) PCT Filed: Jul. 10, 2014
(86) PCT No.: PCT/US2014/046179

§ 371 Date: Jan. 8, 2016

Related U.S. Application Data
(60) Provisional application No. 61/844,466, filed on Jul. 10, 2013.

(51) Int. Cl. H04W 48/04; H04M 1/725

(52) U.S. Cl. CPC H04W 48/04; H04M 1/72577; H04M 2250/10

(57) ABSTRACT

A computer-implemented method is disclosed for controlling access to a mobile device operated by a user. The method includes the steps of determining a whether a physical speed of a mobile device exceeds a predefined threshold, and limiting the user's access to the mobile device responsive to whether the physical speed of the mobile device exceeds the predefined threshold. The step of limiting the user's access to the mobile device includes the steps of locking the mobile device if the mobile device is configured to receive no notices, and allowing conditional access to the mobile device if the mobile device is configured to receive notices

### PRIORITY

The present application claims priority to U.S. Provisional Patent Application Ser. No. 61/844,466 filed Jul. 10, 2013, the disclosure of which is hereby incorporated by reference in its entirety.

### BACKGROUND OF THE INVENTION

It is widely known that the use of mobile communications devices to make phone calls while driving can lead to erratic, careless and dangerous driving. Many jurisdictions have enacted laws restricting the use of mobile phones by a driver. Some bans are directed to any use, while others are directed specifically to the use of handheld mobile phones, thereby allowing the use of hands-free kits to engage in phone calls. Mobile phones however, also possess messaging technology the ability to make phone calls, and further, more modern cell phones possess the ability to browse the internet. Compared to phone calls, messaging, including text message and emailing, and internet browsing require the user to read from the phone's display. If that user is driving at the same time, the user must be distracted from the road and his mirrors. Furthermore, if a user is entering data into the phone, for example creating an outgoing message, or navigating a website, this will often require him to take at least one hand off the steering wheel and to take his gaze from the road. It is therefore accepted that it is very dangerous to engage in messaging or the like while driving. But, even though there is acknowledged danger, it can still be very tempting for a user to engage in such practices.

A number of systems have been proposed to deter or prevent drivers from using their phones while driving. Some users who are particularly safety conscious may choose to obtain or implement one of such existing system themselves. Other users may have such a system forced upon them, for example, by a parent, employer or insurance company. A user who has chosen to use the system may be trusted to be reasonably diligent in its use. On the other hand, unwilling users may not be pleased to have their device usage limited, and may take steps to bypass the limitation. To maintain the desired safety standards, it is important to ensure that a drive cannot simply choose to bypass a system attempting to limit their device usage. Furthermore, in a time when many hacks may be available, for example on the Internet, to alter the functionality of various mobile communication devices, it is important that any safety-oriented device usage limiting system be secure and difficult to override. Preferably, such a system would be difficult to override both during a journey, i.e., a temporary override, and as long as a long term override, for example, disabling the system completely.

It is important to note however, that in many cases, users may simply be passengers in vehicles and as such, are not engaging in a dangerous activity by using mobile devices. The mobile communications device usage of such users should not be adversely affected by a safety-oriented device usage limiting system.

### SUMMARY OF THE INVENTION

Methods and systems for limiting the usage of a mobile device while driving are provided. According to an aspect of the present invention, a computer-implemented method is provided for controlling access to a mobile device operated by a user. The method comprises determining a physical speed at which the mobile device is moving, and upon determining that the physical speed exceeds a predefined threshold speed, limiting the user's access to the mobile device, which may comprise locking the mobile device if the mobile device is configured to receive no notices and allowing conditional access to the mobile device if the mobile device is configured to receive notices. The method may further comprise, upon determining that the physical speed does not exceed the predefined speed, providing access to the mobile device for a predefined period of time.

Determining the threshold speed of the mobile device may include acquiring the threshold speed from an On-Board Diagnostics (OBM) system of a vehicle or via a Global Positioning System (GPS) transceiver. Limiting access to the mobile device may further comprise sending a notice request to a mobile device management (MDM) server, receiving a device lock command from the MDM server in response to the notice request, and locking the mobile device in response to the device lock command.

Allowing conditional access to the mobile device may comprise presenting the user with an Attention Verification Test (AVT) to determine whether the user is entitled to access to the mobile device based at least in part on the user's response to the ATV.

According to another aspect of the present invention, one or more non-transitory computer-readable storage media are provided, having stored thereon executable instructions that, when executed by one or more processors of a mobile device operated by a user, cause the mobile device to at least determine a physical speed at which the mobile device is moving, upon determining that the physical speed exceeds a predefined threshold speed, limit the user's access to the mobile device, comprising locking the mobile device if the mobile device is configured to receive no notices, allowing conditional access to the mobile device if the mobile device is configured to receive notices, and upon determining that the physical speed does not exceed the predefined threshold speed, providing access to the mobile device for the predefined period of time.

Allowing conditional access to the mobile device may include allowing the user to access one or more applications associated with the mobile device if the user is determined to be a passenger of a vehicle. Allowing conditional access to the mobile device may include denying the user access to the mobile device if the user is determined to be a driver of a vehicle. Limiting the user's access to the mobile device may be based at least in part, on one or more commands from a mobile device management (MDM) server.

According to another aspect of the present invention, a device-configured-control access to the device by a user is provided. The device comprises one or more processors and memory, including instructions executable by one or more processors to cause the device to at least determine a physical speed at which the mobile device is moving and upon determining that the physical speed exceeds a predefined threshold speed, limit the user's access to the mobile device, comprising locking the mobile device if the mobile device is configured to receive notices, and allowing conditional access to the mobile device if the mobile device is configured to receive notices.

Determining the threshold speed of the mobile device may include acquiring the threshold speed from an On-Board Diagnostics (OBM) system of a vehicle. Limiting the user's access to the mobile device may be based at least in part on one or more commands from a mobile device management (MDM) server. Allowing conditional access to the mobile device may include determining whether the user is a driver of a vehicle.

### BRIEF DESCRIPTION OF THE DRAWINGS

The following invention may be further understood with reference to the accompanying drawings in which:

FIG. 1 shows an illustrative diagrammatic view of a mobile communications device in accordance with an embodiment of the present invention;

FIG. 2 shows an illustrative diagrammatic view of a process in accordance with an embodiment of the present invention for operating a mobile communication device;

FIGS. 3A-3C show illustrative diagrammatic views of bypass prevention processes in accordance with certain embodiments of the present invention;

FIGS. 4A-4C show illustrative diagrammatic views of interface screens of a mobile communication device in accordance with certain embodiments of the present invention; and

FIG. 5 shows an illustrative diagrammatic view of a computing system for implementing aspects of the present invention in accordance with at least on embodiment of the present invention.

The drawings are shown for illustrative purposes only.

### DETAILED DESCRIPTION

The method and apparatus of the present invention provides an anti-texting program that limits the use of mobile communications devices while driving. As used herein, the term “anti-texting program” refers to any software and/or hardware implementation that limits the use of a mobile communications device while the user of the device is in a moving vehicle. In some cases, the anti-texting program may restrict or otherwise disable the use of certain aspects of the device such as texting voice calls, Internet browsing and the like. In other cases, the anti-texting program may restrict use or access to the entire device. Such restrictions are typically temporary and/or conditional. For example, the restriction may be removed when the speed of the vehicle falls below a predefined threshold or if it is determined that the user is merely a passenger of the vehicle. On the other hand, the restriction may be designed to be relatively difficult to bypass so as to remain effective.

Throughout the specification, the terms mobile communications device, mobile device, phone, mobile phone, or the like are used interchangeably. In various embodiments, mobile communications devices may include laptops, tablet devices, cellular phones, smartphones, and the like. The mobile communication devices may be configured to implement operating systems (OS) such as iOS provided by Apple, Inc. of Cupertino, Calif., Android, provided by Google, Inc. of Mountain View, Calif., Windows Phone, provided by Microsoft Corporation or Redmond, Wash., Blackberry, provided by Research in Motion Limited (RIM) of Waterloo, Ontario, Canada; and the like.

In some embodiments, inherent features provided by the basic operating system of a mobile device may be utilized to install an anti-texting program that the user cannot bypass. One of the inherent features of an operating system is to allow a user to determine when and how he or she may be interrupted or advised of some activity detected by an application running on the mobile device. For example, a user may want to know if another call is coming in, if an email or text is received, etc. In keeping with the desire to give the user maximum flexibility, the user may choose no notification. For example, iOS provides notification options for the user who may select none, banner or alert. The alert notification requires the user take action in the noticed program to continue. Stated another way, no program can intrude upon the user or launch without an express launch by the user.

In certain embodiments, such notification options provided by the operating system of the mobile device may be used by the anti-texting program to disable the entire device and force the user to launch the anti-texting program if the user wants to use the device. If the user sets the notification of the anti-texting program to none and the phone is travelling above a threshold speed, the program disables the phone and sets its display to an idle mode. The mobile phone remains in idle mode until the speed sensed by the phone falls below the threshold speed of the anti-texting program or the user launches the anti-texting program. If the user sets the notification to alert or banner, then the user is presented with the opportunity to launch the anti-texting program and take a test to see if the user is a driver or a passenger.

In some embodiments, the anti-texting program may be pushed to the user's mobile device by governmental authorities or by an enterprise that owns the phone and provides it to the user. If the user fails to download the anti-texting program or deletes the program, the device is disables. The anti-texting program, upon installation, may set the notification of the mobile device to a predetermined setting (e.g. alert or banner) to prevent disabling of the anti-texting program. The anti-texting program may return the phone to idle or lock screen if notification is set to none. If notification is set to banner or alert, the user may be given an opportunity to launch the program and take a driver/passenger test. If the test confirms the user is a passenger, the user may have unlimited use of the phone. Otherwise, the phone may be disabled until the vehicle stops or slows to less than the threshold speed.

In some embodiments, the installation and/or operations of the anti-texting program may be controlled, at least in part, by mobile device management (MDM) systems or servers. Device providers may restrict the programs stored on their products. For example, Apple requires any program for its iPhone to be approved by Apple before the program is offered for sale through approved Apple distribution chains. However, enterprise users have more freedom of operation. They may install programs that are otherwise restricted by Apple because Apple authorizes enterprise users more freedom to control the operation of enterprise devices. In the event the anti-texting program is not approved by the device provider, it is still possible to enable installation and operation of the anti-texting program on the device by using services provided by third parties who provide MDM software and services.

In general, MDM software and services may be provided to secure, monitor, manage and support mobile devices deployed across mobile operators, service providers and enterprises. MDM functionality typically includes over-the-air (OTA) distribution of applications, data and configuration settings for all types of mobile devices, including but not limited to wireless communications devices capable of sending or receiving text message, sending or receiving global positioning system signals, cell phones, mobile phones and smart phones, tablet computers, ruggedized mobile computers, mobile printers, mobile POS devices, and others. This applies to both company-owned and employee-owned (BYOD) devices across the enterprise or mobile devices owned by consumers. By controlling and protecting the data and configuration setting for all mobile devices in the network, MDM can reduce support costs and business risks, thereby optimizing the functionality and security of a mobile communications network while minimizing cost and downtime.

A typical MDM implementation includes a server component running on a MDM server, which send management commands to the mobile devices as well as a client component running on the mobile device, which receives and implements the management commands dispatched by the MDM server. In some cases, a single vendor may provide both the client and the server; in other cases, client and server will come from different sources.

In some embodiments, it is necessary to connect a mobile device to the handset or install a SIM in the mobile device in order to make changes and updates to the mobile device. In some other embodiments, users operating a mobile device may request client-initiated updates. In some other embodiments, central remote management uses commands sent over the air (OTA). An administrator at the mobile operator, an enterprise information technology data center or handset original equipment manufacturer (OEM) can use an administrative console to update or configure any one handset, group or groups of handsets. This provides scalability benefits particularly useful when the fleet of managed devices is large in size.

Over-the-air (OTA) programming capabilities may include the ability to remotely configure a single mobile device, an entire fleet of mobile devices or any IT-defined set of mobile devices; send software and OS updates; remotely lock and wipe a device, which protects the data stored on the device when it is lost or stolen; and remote troubleshooting. In some embodiments, OTA commands are sent as part of binary SMS messages, which are messages including binary data.

In some embodiments, a configuration profile containing the MDM server information may be sent to a client mobile device. If the device is controlled by an enterprise, the enterprise may directly install a configuration profile on the device that contains the address and other information regarding the MDM server used for the anti-texting program. If the device is owned and controlled by an individual, the individual may install the anti-texting program and install a configuration profile on the device that contains the address and other information regarding the MDM server used for the anti-texting program. It is possible the anti-texting program is pre-installed on the device with the MDM server by adding a suitable configuration profile to the device. The user, either the enterprise or the individual, may be presented with information about what will be managed or queried by the MDM server. The user may install the profile in the device to be managed. The device may be enrolled with the program is installed. The MDM server may validate the device which will then allow the MDM server to access the device. The MDM server may send push notifications prompting the device to check for tasks or queries.

As discussed above, the anti-texting program may conditionally limit the use of a mobile device based on the speed of a vehicle. Such speed may be obtained in real time via various methods such as via a Global Positioning System (GPS) transmitter/receiver (transceiver) or through On-Board Diagnostics (OBD) capabilities provided by the vehicle.

OBD data, typically accessible via hardware and/or software interface provided by the vehicle, may include various real time performance and/or diagnostic information about various aspects of the vehicle such vehicle speed, revolutions per minute (RPM), fuel level, emission testing code, and the like. In some embodiments, an OBC computer access port in a vehicle may be used to provide the speed signal of the on-board diagnostic equipment to a mobile device (e.g., to a SIM card on a cell phone).

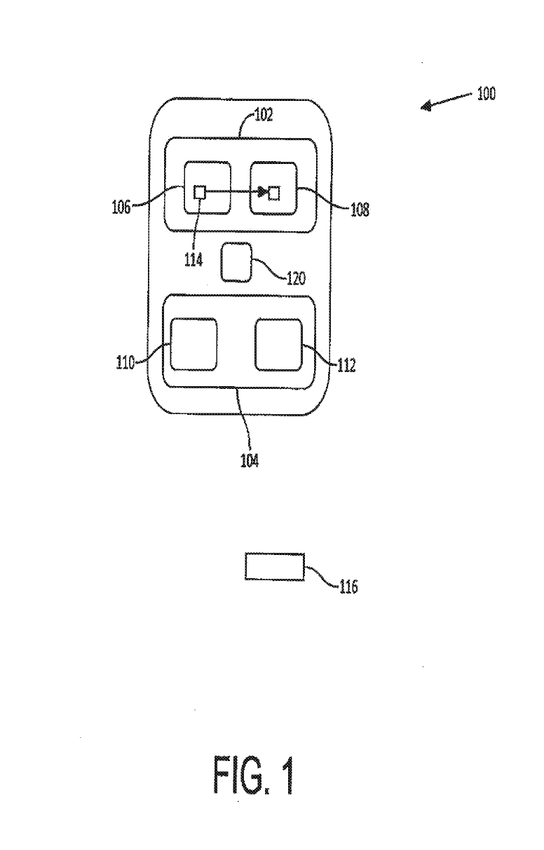

FIG. 1 illustrates an example mobile communication device 100 adapted to implement the present invention, in accordance with at least one embodiment. The device 100 comprises a Subscriber Identity Module (SIM) 102 and a user interface 104. The SIM Module 102 includes a SIM Memory 106 and a SIM Processor 108. The user interface 104 includes a display 110 and a data entry unit 112. The user interface 104 may comprise a unitary interface such as a touch-screen, wherein the display 110 and data entry unit 112 are combined, or may comprise a separate display 110 and data entry unit 112. It will be understood that the mobile communications device 100 may comprise additional components such as a Power Supple Unit (PSU) and radio unit but these are not shown for the sake of clarity.

The application 114 to implement the method of the invention is stored in the SIM memory 106 and is executed by a SIM operating system on the SIM processor 108.

The mobile communications device 100 may further comprise a Global Positioning System (GPS) transmitter/receiver (transceiver) 120. The GPS transceiver may be implemented on the mobile communications device 100 or on the SIM 102.

There is further shown a speed acquiring element 116, which is adapted to calculate or receive the speed at which the mobile communications device 100 is moving and provide the speed information to the SIM application 114. The speed acquiring element 116 may be implemented on SIM itself on the mobile communications device 100 or may be an external device in the communication with the SIM application.

In some embodiments, the speed acquiring element 116 may include connection to an OBM port provided by a vehicle. The acquiring element 116 may include a reader that is plugged into or is otherwise connected (via wireless or wirelessly) to the OBD port. The reader may use the OBD access port to read the speed signal data provided by the OBM system of the vehicle. The reader may be equipped with a wired or wireless connection to a mobile device for transmitting the speed signal data to the mobile device. If the mobile device is equipped has a SIM card, the speed signal data may be made available either directly to the SIM card or to a location is accessible by the SIM card. The SIM card may then use the speed signal data as an input to the anti-texting program.

Still referring to FIG. 1, the application 114 that implements the method of the invention may be installed on the mobile communications device 100 using various methods. One way to install the application 114 is to carry out the installation at the personalization stage of the mobile communications device 100. The term personalization will be understood to refer to the process of entering the mobile network operator specific information, SIM applications using the SAT interface and other SIM specific information on the SIM. This is in general carried out at manufacture or prior to the SIM being made live on the communications network.

Personalization is normally carried out by the SIM manufacturer but may also be carried out by a third party or by a network operator. It is possible for the full personalization of the mobile communications device to take place in a number of stages with one or more stages being carried out by a different party. Loading the application 114 can be carried out at any stage in the personalization process, for example at a Point-of-Sale location. In this was the owner of the mobile communications device, who may be different to the user thereof may choose to install the application for implementing the method of the invention on purchase of the mobile communications device.

Alternatively, the application 114 may be installed on the mobile communications device after it has been purchased, by transmission over the mobile communications network. This may be referred to as a push operation. 3GPP and ETSI standards specify protocols and procedures necessary to enable a SIM application using the SIM Application Toolkit interface to be downloaded to a SIM remotely using the Short Message Service. The mobile operator who issues the SIMs must know the keys required to authorize the downloads and have a platform which can pack the application into the required amount of properly formatted short messages.

The same network transmission download process can also be used to send configuration changed or upgrades, such as changes to the various timings or the speed threshold, to the application 114 after installation. However, such upgrades and changes are controlled by the network and not the user.

In North America, many wireless carriers operate on the code division multiple access standard, CDMA2000, to send and receive voice, text and other data transmissions, CDMA cell phones do not have a SIM card, so the SUM applications 114 of invention cannot not be part of a CDMA handset. Nevertheless, CDMA cell phones have the ability to receive, to store and execute software applications. New CDMA cell phones can be manufactured with built-in anti-texting application (not shown) or its equivalent or for CDMA cell phones already in use, the service provider may push an anti-texting application or its equivalent to its served cell phone. As an alternative, the anti-texting software could be automatically downloaded to CDMA cell phones without notice to the cell phone owner.

It will be understood by the person skilled in the art that the push installation of the application implementing the method of invention or of the anti-texting application can be made at any time, with or without the permission of the cell phone user. For example, a state government or the federal government could mandate that all cell phone users download a suitable phone limitation activation by a selected activation date. If a user fails to download the usage limitation application, texting and other faculties of the cell phone could be disabled by the cell phone carrier until the cell phone user downloads the usage limitation application. After the activation date, the cell phone carrier would query each cell phone seeking access to its cell service and would deny all service or limit service to only voice transmissions if the cell phone seeking service did not respond positively to the query about the presence and operation of usage limitation.

The anti-texting application may be implemented with any mobile phone that carries a GPS receiver, including SIM-card phones, CDMA phones and other phones with GPS receivers. The basic operation is as follows. An anti-texting vendor provides a link to a mobile phone. The vendor may be a mobile carrier, an independent vendor, an enterprise that provides mobile phones to its members, or an internet service provider who provides e-mail, browsing and ancillary services to mobile phone users. The link may be provided the phone user via an e-mail or an SMS message, or a posting on a web site. When the phone user accepts the link, the anti-texting program is downloaded and installed on the mobile phone. The anti-texting program may be based on speed measured by the GPS receiver carried on the phone.

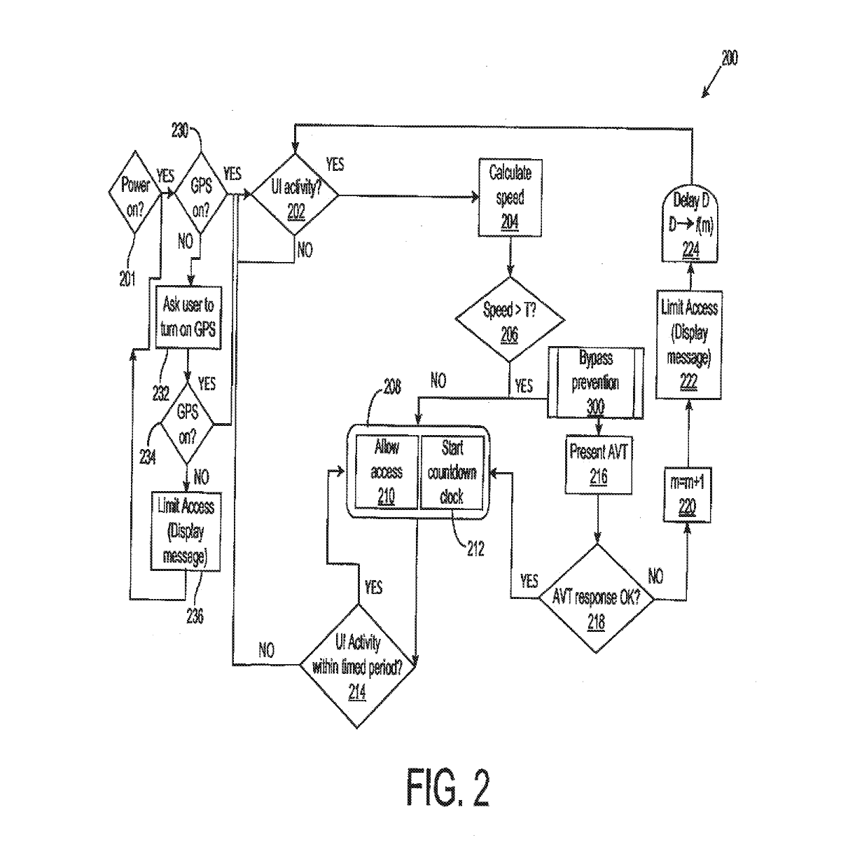

FIG. 2 illustrates an example process 200 for implementing the present invention, in accordance with at least one embodiment. Aspects of the process 200 may be performed, for example, by a mobile communications device 100 discussed in connection with FIG. 1 or a suitable computing device. Some or all of the process 200 (or any other processes described herein, or variations and/or combinations thereof) may be performed under the control of one or more computer/control systems configured with executable instructions and may be implemented as code (e.g., executable instructions, one or more computer programs or one or more applications) executing collectively on one or more processors, by hardware or combination thereof. The code may be stored on a computer-readable storage medium, for example, in the form of a computer program comprising a plurality of instructions executable by one or more processors. The computer-readable storage medium may be non-transitory. The order in which the operations are described is not intended to be construed as a limitation, and any number of the described operations may be combined in any order and/or parallel to implement the processes.

Referring now to FIG. 2, in which like parts have been given the same reference numerals as before, there is shown a flowchart of the method of the invention. In some embodiments, the process 200 may include detecting 201 that a mobile communications device (e.g., mobile communication device 100 of FIG. 1) is powered on. If so, the process 200 may optionally include checking 230 whether the GPS is turned on the prevent the user from intentionally bypassing the anti-texting program. In some embodiments, the GPS check 230 is omitted.

At step 202, the process 200 may include monitoring a user interface of the mobile device (such as the user interface 104 or FIG. 1) for input from the user. Such monitoring may continue indefinitely until user input is detected or for a predefined period of time. When user input is detected, a vehicle speed or a speed at which the mobile device is moving may be acquired or calculated 204. Next in step 206, the acquired speed may be compared to a predefined threshold speed. An exemplary threshold speed is between nineteen and twenty kmph (equivalent to 12 mph). This threshold sped was chosen as it is unlikely that a person would be moving at this speed on their own without the assistance of a vehicle of some sort. In various embodiments, the threshold speed may be defined by the device manufacturer, an MDM server, government agencies, users of the mobile devices and the like.

If the mobile communication device 100 is moving below the threshold speed, the process 200 may comprise a two-part step 208. At the first sub-step 210, the process 200 allows the user to access the full functionality of the mobile communications device (such as the mobile device 100 of FIG. 1). At the second sub-step 212, the proves 100 may include beginning a countdown of a predetermined period of time. Typically, this period of time is about fifteen seconds but may be longer or shorter in various embodiments.

At step 214, the user interface (such as the user interface 104 of FIG. 1) may be monitored for user activity during the countdown period. Such monitoring may be performed, for example, by the application 114 discussed in connection with FIG. 1. If user activity is detected, the process 200 includes returning to step 210, where the countdown timer may be reset. If no activity is detected for the countdown timer period, the process 200 may include returning to step 202, where user input is monitored. If user input is detected, the process 200 may proceed to step 204 to check the vehicle speed or the speed at which the mobile communications device is moving. In this way, if a user is continually using their mobile communications device while the device is moving slower that the threshold speed, their usage will not be interrupted. In this situation, the term “continually” may include interaction with a data entry unit (such as the data entry unit 112 of FIG. 1) at least once within each countdown period of the countdown clock of step 212.

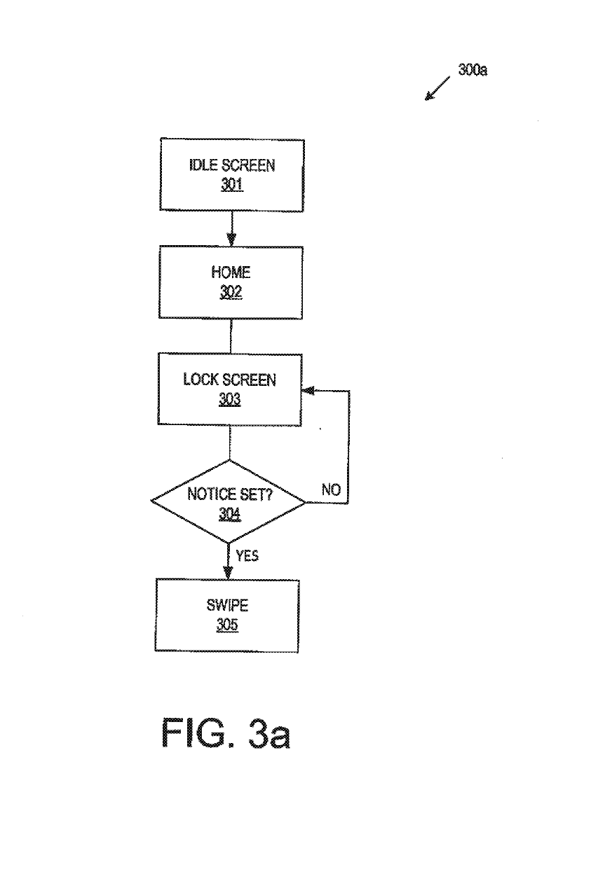

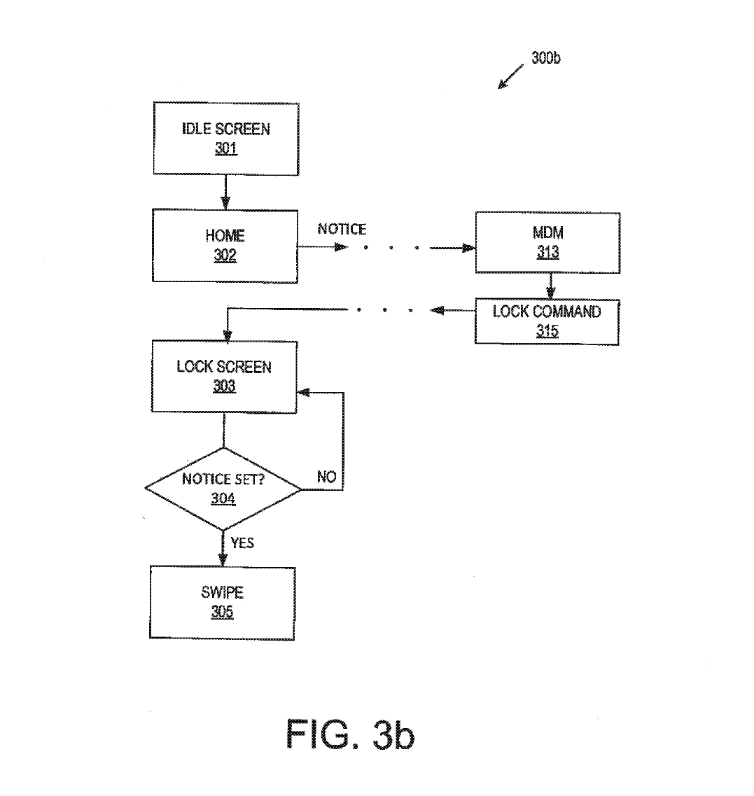

Returning now to step 206, if the detected speed is above the preset threshold, the mobile communications device may be deemed to be moving in a vehicle and/or moving above a prescribed speed limit. In this case, the process 200 may include a subroutine 300 for preventing user bypass. Such bypass prevention routine 300 may be implemented by FIGS. 3A or 3B (discussed below). In some embodiments, the bypass prevention subroutine 300 may be omitted.

In either case, the process 200 may proceed to step 216, where a user may be presented with an Attention Verification Test (AVT) to determine whether the user is entitled to full functionality of the device. The AVT may be displayed, for example, by way of the display 110 of the user interface 104 of FIG. 1. A response from the user may be received by way of a data entry unit (such as the data entry unit 112 of FIG. 1).

At step 216, the process 200 may include checking 218 of the user response is adequate to prove that the user is paying sufficient attention to the mobile communications device. If the user passes the AVT, the process 200 may include proceeding to step 210, allowing the user access to the full functionality of the mobile communications device for countdown period before returning to step 202. If the user does not pass the AVT, the process 200 may include proceeding to step 220 where a count of the number of failed AVTs is incremented. At step 222, the user's access to the functionality of the mobile communications device may me limited by a message (e.g., from the SIM application 114) being displayed (e.g., on the display 110 of the mobile device 100 of FIG. 1). Then the process 200 may include proceeding to step 224 where a delay, which is dependent on the failed AVT count, is implemented before the process 200 returns to step 202. In this way, if the user fails to provide suitable response to the AVT, she may have to wait for a period of time until she is presented with another AVT. In the waiting period, she may not have access to the functionality of the mobile communications device, as the display 110 will be monopolized by one or more messages (e.g., from the SIM application 114 of FIG. 1). The waiting period may be implemented as a function of the count of failed AVTs. For example, waiting period may get longer each time the user fails the AVT. The failed VT count may be reset if the user passes an AVT or if the mobile communications device has been or is moving at a speed below the threshold speed for a predefined period.

Referring not to step 201, the mobile communications device may inform the SIM operating system of its capabilities upon start-up. For example, a class n terminal, as defined according to ETSI Standard 102.223, may inform the SIM operating system on start-up of its support for geographical location reporting. Once the mobile communications device is powered on, an application (such as the application 114 of FIG. 1) may notify the SIM operating system that an action must be performed as soon as the SIM operating system has started-up. The SIM operating system may then request that a Proactive Command is sent as soon as a request is received from the mobile communications device 100. An exemplary Proactive Command comprises a response “91XX” to the first command send to the SIM operating system by the mobile communications device. The mobile communications device may then use a FETCH command to retrieve the Proactive Command from the SIM operating system.

Referring now to step 202, an application (such as the application 114 of FIG. 1) may monitor the user interface using the GET INPUT Proactive Command until the mobile communications device is turned off. When the user presses a key on the data entry unit 112, the mobile communications device may return the response to the GET INPUT Proactive Command to the SIM.

Referring now to step 204, the speed at which the mobile communications device is travelling may be acquired in a number of different ways. In some embodiments, speed data may be acquired via an OBD port or interface provided by a vehicle, such as discussed above. In other embodiments, the implementation of speed acquisition may depend on the functionality of the mobile communications device.

In some embodiments, based on information obtained from step 201, the SIM operating system may be aware of the capability of the mobile communications device with regards to geographical location reporting. An application (such as the application 112 of FIG. 1) may tailor the Proactive Command to that capability. Different Pro-Active Commands that may be presented by the application to the mobile communications device, depending on the class of mobile communications device.

In the case of a class n mobile communications device, the mobile communications device may comprise a GPS application (not shown) to provide GPS information on the mobile communications device. In this case the Proactive Command may include GEOGRAPHICAL LOCATION REQUEST with parameters indicating the requirement for speed measurements. The speed information (or an error message) may be subsequently sent back to the application using the ENVELOPE command GEOGRAPHICAL LOCATION REPORTING. In this case, the GPS application of the mobile communications device may provide the functionalities of the speed acquiring element 116 discussed in connection of FIG. 1.

In some embodiments, the SIM itself may incorporate a GPS receiver in which case the SIM application may request the geographical information directly from the SIM based GPS receiver. In this case, the GPS application of the SIM may provide the functionalities of the speed acquiring element 116 discusses in connection of FIG. 1.

In the case of class e mobile communications device, the Proactive Command may include OPEN CHANNEL, which relates to a packet data service bearer. Once a packet data service is opened, the mobile communications device may inform the application (such as the application 114 of FIG. 1). The application may then use the SEND DATA Proactive Command to send a request for location information to a Mobile Location Centre (MCL) (not shown) and the RECEIVE DATA Proactive Command to receive the speed information back from the MLC. The data sent and received using these commands may be according to the 3GPP standard TS 23.271 for Uplink Time Difference of Arrival (U-TDOA) measurements. The 3GPP standard includes details on the data that needs to be sent to and received from an MLC to support getting location information using the UTDOA method. In this case, the MLC may provide the functionalities of the speed acquiring element 116 discussed in connection of FIG. 1.

For mobile communications devices that are neither class e nor class n, but are able to run SIM applications using the SIM Application Toolkit, the Proactive Command used may include SEND SHORT MESSAGE. An SMS message may be sent requesting the speed of the user equipment from a location server (not shown). In this case the information may be sent back from the location server via an SMSPP data download short message. In this case, the location server may provide the functionalities of the speed acquiring element 116 discussed in connection of FIG. 1.

Referring not to step 216, in some embodiments, a series of DISPLAY TEXT and GET INPUT Proactive Commands may be used (e.g., by the application 114 of FIG. 1) to present the user with a sequence of characters and to receive the user's response thereto. The DISPLAY TEXT command may cause a message to the user to be displayed on a display (such as display 110 of FIG. 1) requesting that the user enter one or more specific characters, digit or non-digits, using a data entry unit (such as the data entry unit 112 of FIG. 1). The entered character(s) may be retrieved (e.g., by the application 114 of FIG. 1) using the GET INPUT command. In order to enter a valid response, the user's response must be the correct character(s) and must be entered within a specific time period. As part of this step 216, two or more timers (not shown) may be maintained to control how long each character is displayed on the display 110 and to verify that the user has entered a response within the required time. In some cases, each character is displayed for approximately 0.5 seconds, and the user response must be received within 2 seconds. In other cases, the timing parameters may vary,

In some embodiments, limiting the user's access to the mobile communications device may include monopolizing the user interface (such as the user interface 104 of FIG. 1), in particular the display (such as the display 110 of FIG. 1), of the mobile communications device such that the user cannot use the interface to access the functionalities of the device. If the button or menu option create a text message is not visible, then the user cannot select it. The step of monopolizing the user interface may comprise using the DISPLAY TEXT Proactive Command to display a message on the display of the device. This may be combined with a timer to control how long the message is displayed, and thus how long the functionality of the mobile communication device is limited. It is possible that a series of DISPLAY TECT commands may be required to ensure the user interface 104 is monopolized for a required period of time. The message may comprise black screen, a symbol indicating that the user is not currently permitted to access the functionalities of the mobile communications device.

In some embodiments, the SIM application (such as the SIM application 114 of FIG. 1) may be adapted to allow a GPS system on a mobile communications device be used for navigation even while the user's access to the functionality of the mobile communications device has been limited by the SIM application. Those skilled in the art have the ability to white-list applications such as the one outlined here but monopolize other applications.

In some embodiments, the restricted access may pertain only to a subset of the functionalities of the device. For example, a user may still be allowed to make phone calls and/or use a GPS navigation application of the device but prevented from sending text messages. In some embodiments, the restrictions may only pertain to a subset of operations associated with an application. For example, a user may still be allowed to view incoming text messaged but prevented from composing and sending new text messages.

In some embodiments, when a user is allowed access to the mobile communications device, the user interface is not monopolized. The user interaction with the device may not be monitored (e.g., by the application 114 of FIG. 1 using the GET INPUT Proactive Command). In addition, the speed of the mobile communications device may be monitored. In some embodiments, such monitoring may occur in the background and the user is not aware of it.

In an optional alternative method according to the invention, the user is presented with a question, between steps 206 and 216, to determine if the user is currently the driver of the vehicle. If the user is determined to be the drive of the vehicle, then access to the functionality of the mobile communications device may be limited. Otherwise, the process 200 may proceed to step 216.

The method of the invention may include further steps to ensure that the user does not bypass the safety features of method by switching off the GPS functionality no their mobile communications device. For example, at step 230, the process 200 may include checking that a GPS transceiver (such as the GPS transceiver 120 of FIG. 1) is turned on. If the GPS transceiver is on, the process 200 may include proceeding to steps 202 to monitor the user interface. However, if the GPS transceiver is switched of the process 200 may include proceeding to step 232, where the user is asked to turn on the GPS transceiver. The process 200 may include verifying, at step 234, whether the GOS transceiver has been turned on. If the GPS transceiver has not been tuned on, the process 200 may include proceeding to step 236, where the user's access to the functionality of the mobile communications device may be limited as described previously. For example, a blank screen or a notification message may be displayed to the user. If the GPS transceiver has been turned on, the process 200 may include proceeding to step 202, where the user interface may be monitored for interaction from the user.

In some embodiments, the GPS transceiver may be turned of or switched into an idle mode, so as to conserve energy when the user's access to the mobile communications device has been limited, for example at steps 222, 224 or 236. This may cause the GPS transceiver 120 to cease searching for GPS satellites or local cell towers to acquire location information.

The method of invention may include further steps to ensure that the user does not bypass the safety features of method by utilizing notification options provided on their mobile communications device. FIGS. 3a-b illustrate example bypass prevention routines or subroutines 300a-b, in accordance with some embodiments. In some embodiments, such a bypass prevention routine may be implemented as part of step 300 of FIG. 2, discussed above.

Referring now to FIG. 3a, in response to a determination (e.g., by step 206 of FIG. 2) that the speed of the mobile communications device is above a threshold value, the device may be set 301 to an idle mode. A blank or otherwise idle-mode-indicating screen may be displayed. If the user presses the home button, step 302, a lock screen may be displayed, at step 303. The notification level may be checked, at step 304. If there is no alert set, (i.e., notification is set to none), the lock screen may be displayed, at step 303. To use the device, the user may be required to reduce the speed of the vehicle to less than the threshold speed. At that a lower speed, the user may be able to use the device and/or reset the notification on the device (e.g., to banner or alert). If the notification is set to banner or alert, the user may be presented a lock screen which requires the user swipe (at step 205) and launch the anti-texting program. If the user does not launch the anti-texting program after a predetermined period of time, the device may return to the lock screen. Upon swiping or accessing the lock screen, the user may be presented with the Attention Verification Test such in step 216 of FIG. 2.

As discussed above, in some embodiments, the installation and/or operations of the anti-texting program may be controlled, at least in part, by mobile device management (MDM) systems or servers. FIG. 3b illustrates an example implementation of a bypass prevention routine 300b. In some embodiments, such a bypass prevention routine may be implemented as part of step 300 of FIG. 2, discussed above.

In some embodiments, the steps in the subroutine 300b may be similar to those illustrated in FIG. 3a, except that if the device exceeds the threshold speed (e.g., as determined by step 206 of FIG. 2) and the user attempts to access the device via the home screen in step 302, the device connects directly to MDM server at step 313. Such a connection may be via Hypertext Transfer Protocol Secure (HTTPS) or any other suitable protocol. In some embodiments, the device may send a notification request to the MDM server. In some embodiments, the MDM server may store or otherwise obtain device profile information. The profile information may include information about a user's notification settings, the device's speed data and the like. Based on the device profile information, the MDM server may, at step 315, issue a “device lock” command back to the requesting device. Upon receipt of the device lock command, the device may present the user with a lock screen at step 303. The remaining steps of the routine 300b may be similar to those described in connection with routine 300a of FIG. 3a. The user may be prevented from further use of the device unless the user passes an AVT such as discussed in connection with step 216 of FIG. 2 or if the speed of the vehicle drops below the threshold speed.

Those skilled in the art understand that a business enterprise may operate its proprietary MDM server for only devices owned and managed by the enterprise. However, the MDM manager is not required to own the devices it manages. In fact, the function of delivering the “device lock” command may be given from a single MDM for all devices that use the anti-texting software of the invention. Once the device is configured to accept only MDM control, the “device lock” command may be distributed from any one or more web-based MDM servers.

In various embodiments, MDM may be implemented according to the interfaces, standards, or guidance published by the mobile device manufacturers and/or industry groups or organizations. For example, guidance explaining how to implement MDM and iPhone, iPad and other ios devices have been provided by Apple, Inc. Similar instructions for Android devices as well as other devices have also been provided.

When the bypass prevention routines discussed above in connection with FIGS. 3a-b may be included in the anti-texting process such as illustrated in FIG. 2, it is not limited thereto. Any other program that has notice settings may be adapted to include this bypass prevention routine. For example, a user could have one or more private programs on a device that requires entry of a passcode to use the programs. Even if the user allowed others to use the device, access to selected programs could be restricted to those who possessed the proper passcode for entry after the swipe on the lock screen.

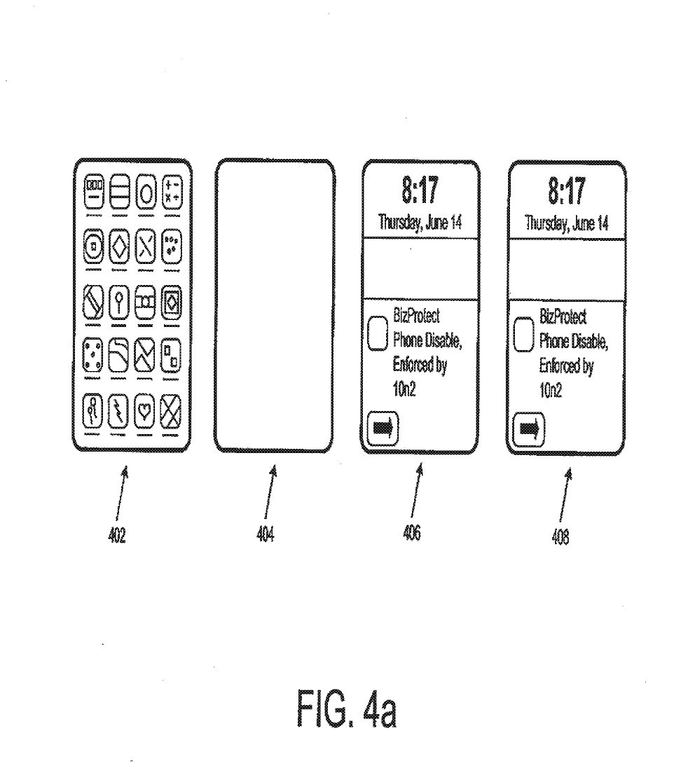

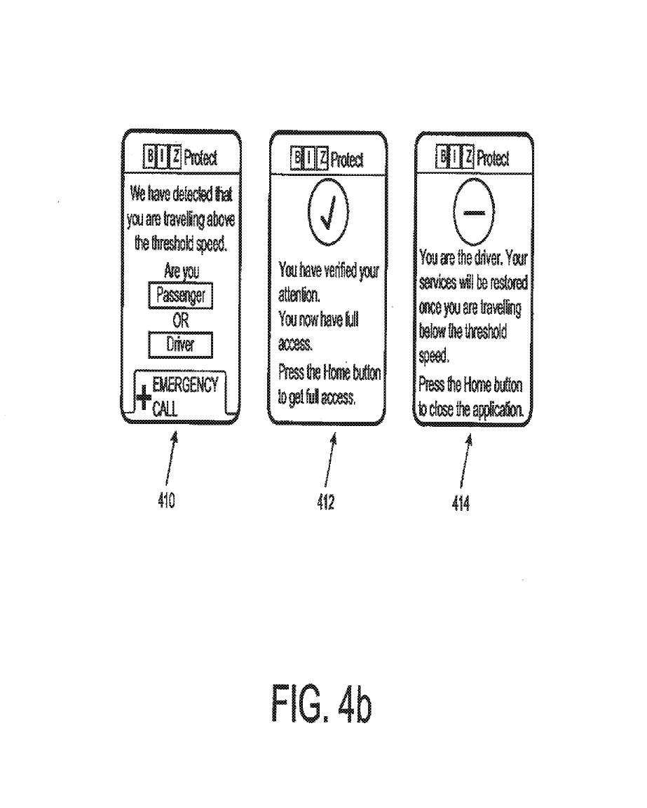

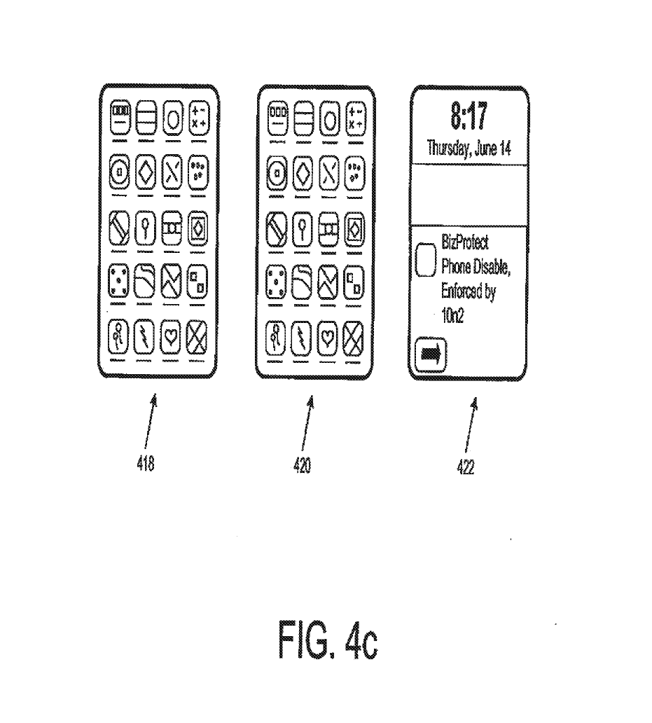

An example series of user interface (UI), as displayed on a mobile communications device (such as an iPhone) is shown in FIGS. 4a-b. In some embodiments, the illustrated UI may be used in conjunction with routine 300a discussed in connection with FIG. 3a. The user may see a home screen 402, for example while using the device when traveling under a threshold speed. The program may check the speed of the device (e.g., via a GPS module or through an OBD port) and force the device to an idle mode screen 404 (e.g., blank or black screen) when the user travels above the threshold speed, unless the user is at the lock screen. When the user hits the home button or similar button on the device from the idle mode, the user may be returned to the lock screen 406, where an alert message may be displayed, indicating that the device is disabled. The device will remain at the lock screen 408 until the user swipes the slide-to-launch arrow at the bottom of the screen or selecting a similar control to launch the anti-texting program. If the arrow is not swiped, the device may return to the idle screen 404. After the user swiped the arrow on the lock screen or otherwise selects a control to launch the anti-texting program, the user may be presented with an Attention Verification Test (AVT) screen 410. Thereafter, the user may be presented with a series of questions which require answers. The time between questions and the time allocated to answering questions may be part of the verification test. The test is designed to allow only a passenger and not a driver to operate the device. If the user passes the verification test, an “access allowed” screen 412 may be displayed to the user indicating that the user is free to access the device. Thereafter, the device may be enabled for a limited period of time. During the time, the speed acquiring element of the device (e.g., via GPS or OBD port) may stop polling for the speed of the device or vehicle to conserve energy. When the access time expires, the device may be returned to the idle mode 404. If the user fails the AVT, and “access denied” screen 414 may be displayed indicating that the user is considered a driver and/or that the device is temporarily disabled until the traveling speed falls below the threshold speed. After a period of time (e.g., 5 seconds), idle mode screen 404 may be displayed.

Another example series of user interface, as displayed on a mobile communications device (such as an iPhone) is shown if FIG. 4c. In some embodiments, the illustrated UI may be used in conjunction with routine 300b discussed in connection with FIG. 3b. The user may see a home screen 418, for example, while using the device when traveling under a threshold speed. The home screen 418 may be similar to the home screen 402 as shown in FIG. 4a. The program may check the speed of the device (e.g., via a GPS module or through an OBD port). When the detected speed exceeds a predefined threshold value, the device may send a notification request to a MDM server, such as described in connection with routine 300b of FIG. 3b. In some embodiments, such a notification request may be sent by a process running in the background and the user may be unaware of the request sent. For example, the UI 420 may remain the same before a response is received from the MDM server. The MDM server may respond to the requesting device with a Device Lock command causing the device to display a lock screen 422 that is similar to the lock screen 406 discussed in connection with FIG. 4a.

In a further embodiment of the invention for use with class n handsets, the SIM application may be adapted to identify if a GPS receiver is active. If the GPS receiver is inactive and the user attempts to use the device, the display on the mobile communications device may provide the user with a menu option to turn on the GPS receiver. If the user does not turn on the GPS receiver, the device is rendered inoperable by the invention. Once the GPS receiver is turned on, the method of the invention reverts to monitoring the speed of the mobile communication device and allowing or limiting usage thereon as appropriate. This global inhibiting function may be used in combination with the Attention Verification Test to enable a passenger in a moving vehicle to freely use all features of the device. This feature may make use of a GPS receiver implemented on the SIM or implemented on the SIM or implemented separately on the mobile communications device. A similar feature may also be implemented in the CDMA anti-texting application.

In another embodiment, the invention further comprises a feature for saving power and thus increasing battery life on the mobile communications device. The mobile communications device may include one or receivers, transmitters or combined receiver/transmitters for handling the GPS signals, voice signals and data signals. For example, a GOS receiver may be running while the application monopolized the user interface. In such a situation the application will terminate operation of the GPS receiver or place the GPS receiver in an idle state. In this case the GPS receiver may temporarily cease searching for satellite transmissions until the application is terminated. This is achieved by sending a command from the SIM application via the SAT interface, requesting the GPS receiver to cease polling. Of course, the feature may be applied to the voice receiver and transmitter, and other applications as well at the GPS receiver and transmitter. Otherwise, conventional hardware running on the device may continue to seek reception or transmission of wireless signals representative of GPS, voice and data.

Throughout the specification, the term “monopolize” and its variations will be understood to have their standard meaning, that is, wherein one element is under the substantially exclusive control of another element. In the case of the present invention, the SIM application maintains substantially exclusive control of the display of the user interface. The term substantially here allows for slight variations in the operation of the SIM application on different mobile communications device handsets, where in some cases, some externally initiated actions may have access to the display. For example, notification of incoming calls may be displayed on the user interface, while the user interface us being monopolized by the SIM application. Furthermore, in the majority of cases, the SIM application will have an option to allow emergency communications.

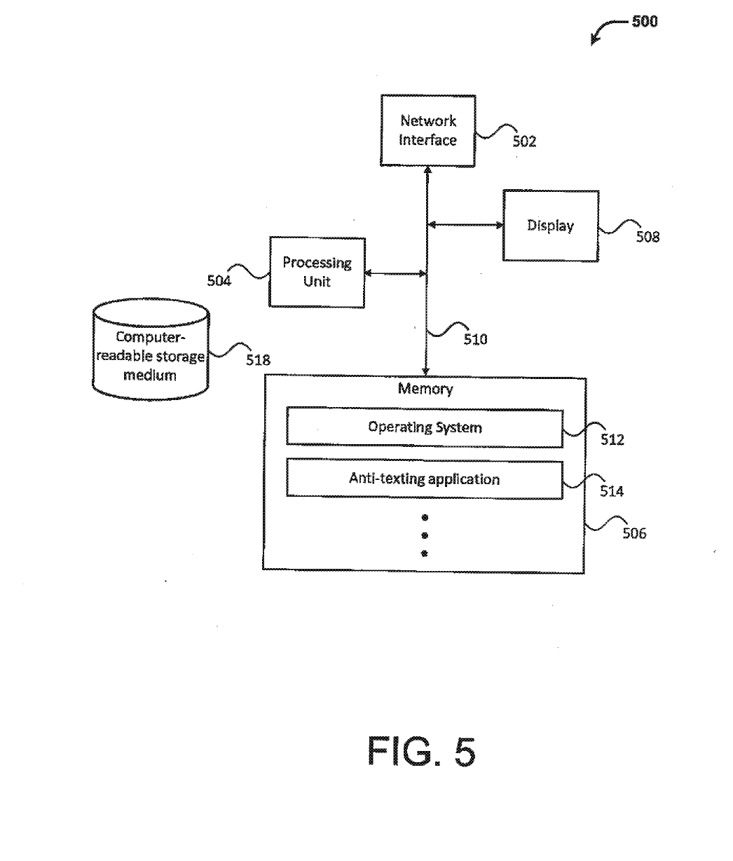

FIG. 5 illustrates example components of a computing device 500 for implementing aspects of the present invention, in accordance with at least one embodiment. In some embodiments, computing device 500 may include many more components that those shown in FIG. 5. For example, the computing device 500 may include a GPS transceiver similar to that illustrated in FIG. 1. However, it is not necessary that all of these generally conventional components be shown in order to disclose an illustrative embodiment.

As shown in FIG. 5, computing device 500 includes a network interface 502 for connecting to a network such as discussed above. In various embodiments, the computing device 500 may include one or more network interfaces 502 for communication with one or more types or networks such as WEE 802.11-based networks, cellular networks, and the like.

In an embodiment, computing device 500 also includes one or more processing units 504, a memory 506, and a display 508, all interconnected along with the network interface 502 via a bus 510. The processing unit(s) 504 may be capable of executing one or more methods or routines stored in the memory 506. The display 508 may be configured to provide a graphical user interface to a user operating the computing device 500 for receiving user input, displaying output, and/or executing applications. In some cases, such as when the computing device 500 is a server, the display 508 may be optional.

The memory 506 may generally comprise a random access memory (“RAM”), a read only memory (“ROM”), and/or a permanent mass storage device, such as a disk drive. The memory 506 may store program code for an operating system 512, one or more anti-texting applications or routines 514 such as those illustrated in FIGS. 2-3, and other applications or routines. The one or more anti-texting applications or routines 514, when executed, may provide various functionalities for limiting the usage of the device 500 as described herein.

In some embodiments, the software components discussed above may be loaded into memory 506 using a drive mechanism associated with a non-transient computer readable storage medium 518, such as a floppy disc, take, DVD/CD-ROM drive, memory card, USB flash drive, solid state drive (SSD) or the like. In other embodiments, the software components may alternatively be loaded via the network interface 502, rather than via a non-transient computer readable storage medium 518.

In some embodiments, the computing device 500 also communicated via bus 510 with one or more local or remote databases or data stores such as an online data storage via the bus 510 or the network interface 502. The bus 510 may comprise a storage network (“SAN”), a high-speed serial bus, and/or via other suitable communication technology. In some embodiments, such databases or data stores may be integrated as part of the computing device 500.

In the specification the terms ‘comprise’, ‘comprises’, ‘comprised’ and ‘comprising’ or any variation thereof and the terms ‘include’, ‘includes’, ‘included’ or ‘including’ or any variation thereof are considered to be totally interchangeable and they should all be afforded the widest possible interpretation. The invention is not limited to the embodiment herein described, but may be varied in both construction and detail within the terms of the claims.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

What is claimed is:

1. A computer-implemented method for controlling access to a mobile device operated by a user, said method comprising the steps of:
determining a whether a physical speed of a mobile device exceeds a predefined threshold;
limiting the user's access to the mobile device responsive to whether the physical speed of the mobile device exceeds the predefined threshold, said step of limiting the user's access to the mobile device including the steps of:
locking the mobile device if the mobile device is configured to receive no notices; and
allowing conditional access to the mobile device if the mobile device is configured to receive notices.

2. The method as claimed in claim 1, wherein said method further includes the step of determining a physical speed of the mobile device.

3. The method as claimed in claim 2, wherein said step of determining the physical speed of the mobile device includes acquiring a vehicle speed from an On-Board Diagnostics (OBM) system of a vehicle.

4. The method as claimed in claim 2, wherein said step of determining the physical speed of the mobile device includes acquiring a vehicle speed from a Global Positioning System (GPS) transceiver.

5. The method as claimed in claim 1, wherein said step of limiting access to the mobile device further includes the steps of:
sending a notice request to a mobile device management (MDM) server;
receiving a device lock command from the MDM server in response to the notice request; and
locking the mobile device in response to the device lock command.

6. The method as claimed in claim 1, wherein said step of allowing conditional access to the mobile device includes the steps of presenting the user with an Attention Verification Test (AVT) to determine whether the user is entitled to access of the mobile device, and determining whether to allow limited access to the mobile device based at least in part on the user's response to the AVT.

7. The method as claimed in claim 6, wherein said method further includes the step of providing access to the mobile device for a predetermined period of time when the user's response to the ACT demonstrates that the user is entitled to access of the mobile device.

8. The method as claimed in claim 1, wherein said method further includes the step of providing access to the mobile device for a predefined period of time when the physical speed is determined to not exceed the predefined threshold speed.

9. One or more non-transitory computer-readable storage media including stored thereon executable instructions that, when executed by one or more processors of a mobile device operated by a user, cause the mobile device to at least:
determine a physical speed at which the mobile device is moving;
limiting the user's access to the mobile device upon determining that the physical speed of the mobile device exceeds a predefined threshold, wherein said step of limiting the user's access includes the steps of:
locking the mobile device if the mobile device is configured to receive no notices;
allowing conditional access to the mobile device if the mobile device is configured to receive notices; and
providing access to the mobile device for the predefined period upon determining that the physical speed of the mobile device does not exceed the predefined threshold speed.

10. The one or more computer-readable storage media as claimed in claim 9, wherein said step of allowing conditional access to the mobile device includes allowing the user to access one or more applications associated with the mobile device if the user is determined to be a passenger of a vehicle.

11. The one or more computer-readable storage media as claimed in claim 9, wherein said step of allowing conditional access to the mobile device includes denying the user access to the mobile device if the user is determined to be a driver or a vehicle.

12. The one or more computer-readable storage media as claimed in claim 9, wherein said step of limiting the user's access to the mobile device is responsive, at least in part, to one or more commands from a mobile device management (MDM) server.

13. A device configured to control access to the device by a user, said device comprising:
one or more processors; and
memory, wherein said memory includes instructions executable by one or more processors to cause the device to at least:
determine whether a physical speed of a mobile device exceeds a predefined threshold speed; and
upon determining that the physical speed of a mobile device exceeds the predefined threshold speed, limiting the user's access to the mobile device, said limiting of the user's access including
locking the mobile device if the mobile device is configured to receive no notices; and
allowing conditional access to the mobile device if the mobile device is configured to receive notices.

14. The device as claimed in claim 13, wherein the physical speed at which the mobile device is moving is determined by acquiring the threshold speed from an On-Board Diagnostics (OBM) system of a vehicle.

15. The device as claimed in claim 13, wherein the limiting of a user's access to the mobile device is responsive, at least in part, on one or more commands from a mobile device management (MDM) server.

16. The device as claimed in claim 13, wherein the allowing of conditional access to the mobile device includes determining whether the user is as driver or a vehicle.
